(19) United States
(12) Patent Application Publication
(10) Pub. No.: US 2026/0029049 A1
(43) Pub. Date: Jan. 29, 2026

(54) ELECTRIC-AXLE OIL IMPINGEMENT PUMP

(71) Applicant: Schaeffler Technologies AG & Co. KG, Herzogenaurach (DE)

(72) Inventors: Kyle Nelson, Delaware, OH (US); Kelly Nelson, Wooster, OH (US)

(21) Appl. No.: 18/782,558

(22) Filed: Jul. 24, 2024

(51) Int. Cl. F16H 57/04

(52) U.S. Cl. CPC F16H 57/0483; F16H 57/0423; F16H 57/0476; F16H 57/0484

(57) ABSTRACT

Electronic axles may utilize lubrication and cooling of an electric motor with pure parasitic collection of fluid from a gearbox assembly, to be fed into a heat exchanging system to cool the rotor of the electric motor. An impingement pump may feed the fluid, without the cost addition of a dedicated fluid pump. Rotation of the gearset carrier may cause an impingement pump catcher to pump the fluid into an impingement pump pipe.

### TECHNICAL FIELD

The present disclosure generally relates to electric axles, and more particularly, to gearsets for the electric axles.

### BACKGROUND

Electric mobility products across battery electric vehicles (BEV) and hybrid platforms in many cases require cooling & lubrication across various aspects of the full assembly. Many electrified drive units require oil collection for the use of downstream lubrication and cooling of bearings, seals, and e-machines. The addition of a dedicated mechanical or electrical pumping unit typically requires the addition of many supporting interfaces, wiring, and programming. Therefore, it would be advantageous to provide a device, system, and method that cures the shortcomings described above.

### SUMMARY

A planetary gearset is described, in accordance with one or more aspects of the present disclosure. In some aspects, the planetary gearset may include: a sun gear; a plurality of planet gears, wherein the plurality of planet gears engage with the sun gear, wherein the plurality of planet gears are configured to revolve around the sun gear; a gearset carrier, wherein the gearset carrier holds the plurality of planet gears, wherein the plurality of planet gears cause the gearset carrier to rotate relative to the sun gear as the plurality of planet gears revolve around the sun gear; a differential, wherein the gearset carrier houses the differential, wherein the gearset carrier is configured to drive the differential via rotation of the gearset carrier; and an impingement pump catcher, wherein the impingement pump catcher is affixed to the gearset carrier and is configured to rotate with the gearset carrier, wherein the impingement pump catcher includes a plate portion and a lip portion, wherein the lip portion radially and axially extends from the plate portion.

In some aspects, the plurality of planet gears may include a plurality of central axes which are parallel to and offset from a central axis of the sun gear.

In some aspects, the planetary gearset may include a plurality of pins and a plurality of bearings, wherein the gearset carrier holds the plurality of planet gears via the plurality of pins and the plurality of bearings.

In some aspects, the plurality of pins may be affixed to the gearset carrier, wherein the plurality of planet gears are connected to the plurality of pins through the plurality of bearings, wherein the plurality of bearings allow the plurality of planet gears to rotate about the plurality of pins.

In some aspects, the plurality of planet gears, the plurality of pins, and the plurality of bearings may be coaxial.

In some aspects, the gearset carrier may be coaxial with the sun gear.

In some aspects, the differential may include a first internal spline and a second internal spline, wherein the first internal spline and the second internal spline are coaxial with the sun gear, wherein the first internal spline and the second internal spline are driven by the gearset carrier.

In some aspects, the plurality of planet gears may be stepped-planet gears including a first gear portion and a second gear portion, wherein the second gear portion axially extends from the first gear portion, wherein the first gear portion engages with the sun gear, wherein the second gear portion does not engage with the sun gear.

In some aspects, the sun gear may include an internal spline, wherein the internal spline axially extends through the impingement pump catcher.

In some aspects, the lip portion may be disposed radially outwards of the plate portion.

In some aspects, the lip portion may be a concave shape defined by an inside diameter of the lip portion.

In some aspects, the inside diameter may face radially inwards towards a central axis of the impingement pump catcher.

In some aspects, the lip portion may be a U-shape.

In some aspects, the plate portion may be axially disposed between the gearset carrier and the plurality of planet gears.

In some aspects, the lip portion may be continuous.

In some aspects, the lip portion may be discontinuous and defines a notch.

A gearbox is described, in accordance with one or more aspects of the present disclosure. In some aspects, the gearbox may include: a planetary gearset including: a sun gear; a plurality of planet gears, wherein the plurality of planet gears engage with the sun gear, wherein the plurality of planet gears are configured to revolve around the sun gear; a gearset carrier, wherein the gearset carrier holds the plurality of planet gears, wherein the plurality of planet gears cause the gearset carrier to rotate relative to the sun gear as the plurality of planet gears revolve around the sun gear; a differential, wherein the gearset carrier houses the differential, wherein the gearset carrier is configured to drive the differential via rotation of the gearset carrier; and an impingement pump catcher, wherein the impingement pump catcher is affixed to the gearset carrier and is configured to rotate with the gearset carrier, wherein the impingement pump catcher includes a plate portion and a lip portion, wherein the lip portion radially and axially extends from the plate portion; an impingement pump pipe including a pipe inlet, wherein the pipe inlet is aligned with the lip portion; and a gearbox housing, wherein the gearbox housing defines: a gearbox sump, wherein the plurality of planet gears and the impingement pump catcher radially extend into the gearbox sump, wherein the gearbox sump is configured to hold a fluid, wherein rotation of the impingement pump catcher causes the impingement pump catcher to pump the fluid from the gearbox sump into the pipe inlet; and a ring gear, wherein the ring gear is disposed radially outwards of and axially aligned with the plurality of planet gears, wherein the plurality of planet gears engage with the ring gear.

In some aspects, a central axis of the pipe inlet may be orthogonal to, and radially offset from central axes of the gearset carrier, the sun gear, and the impingement pump catcher.

An electric drive unit is described, in accordance with one or more embodiments of the present disclosure. In some aspects, the electric drive unit may include: a gearbox including: a planetary gearset including: a sun gear; a plurality of planet gears, wherein the plurality of planet gears engage with the sun gear, wherein the plurality of planet gears are configured to revolve around the sun gear; a gearset carrier, wherein the gearset carrier holds the plurality of planet gears, wherein the plurality of planet gears cause the gearset carrier to rotate relative to the sun gear as the plurality of planet gears revolve around the sun gear; a differential, wherein the gearset carrier houses the differential, wherein the gearset carrier is configured to drive the differential via rotation of the gearset carrier; and an impingement pump catcher, wherein the impingement pump catcher is affixed to the gearset carrier and is configured to rotate with the gearset carrier, wherein the impingement pump catcher includes a plate portion and a lip portion, wherein the lip portion radially and axially extends from the plate portion; an impingement pump pipe including a pipe inlet, wherein the pipe inlet is aligned with the lip portion; and a gearbox housing, wherein the gearbox housing defines: a gearbox sump, wherein the plurality of planet gears and the impingement pump catcher radially extend into the gearbox sump, wherein the gearbox sump is configured to hold a fluid, wherein rotation of the impingement pump catcher causes the impingement pump catcher to pump the fluid from the gearbox sump into the pipe inlet; and a ring gear, wherein the ring gear is disposed radially outwards of and axially aligned with the plurality of planet gears, wherein the plurality of planet gears engage with the ring gear; an electric motor including: a rotor, wherein the rotor is coupled to the sun gear; and a stator; and an output shaft, wherein the output shaft is coupled to the differential, wherein the output shaft is disposed radially inwards of and axially aligned with the rotor.

In some aspects, the electric drive unit may include: a motor housing, wherein the motor housing houses the electric motor, wherein the gearbox housing is affixed to the motor housing, wherein the impingement pump pipe is affixed to the motor housing.

### BRIEF DESCRIPTION OF THE DRAWINGS

The numerous advantages of the disclosure may be better understood by those skilled in the art by reference to the accompanying figures in which:

FIG. 1A depicts a perspective view of a planetary gearset, in accordance with one or more embodiments of the present disclosure.

FIG. 1B depicts a cross-section view of the planetary gearset, in accordance with one or more embodiments of the present disclosure.

FIG. 2A depicts a perspective view of an electric drive unit with the planetary gearset, in accordance with one or more embodiments of the present disclosure.

FIG. 2B depicts a cross-section view of the electric drive unit, in accordance with one or more embodiments of the present disclosure.

FIG. 2C depicts a partial view of FIG. 2B, in accordance with one or more embodiments of the present disclosure.

FIG. 2D depicts a rear view of the electric drive unit with a gearbox housing and planet gears which are hidden to reveal an impingement pump catcher and pipe of the planetary gearset, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to an electric-axle (E-axle) oil impingement pump. Electronic axles may utilize lubrication and cooling of an electric motor with pure parasitic collection of fluid from a gearbox assembly, to be fed into a heat exchanging system to cool the rotor of the electric motor. An impingement pump may feed the fluid, without the cost addition of a dedicated fluid pump. Rotation of the gearset carrier may cause an impingement pump catcher to pump the fluid into an impingement pump pipe.

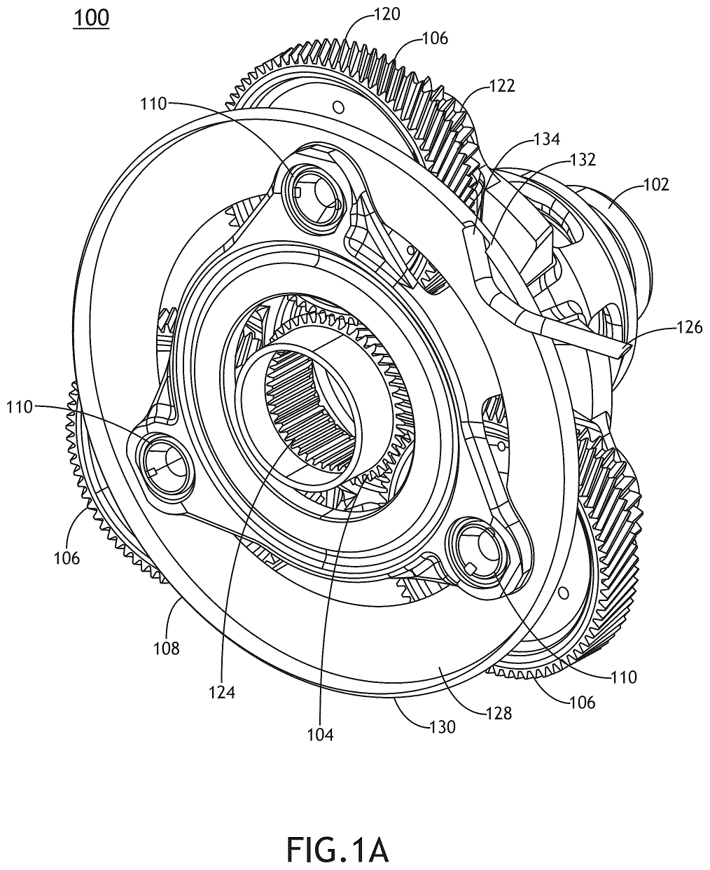

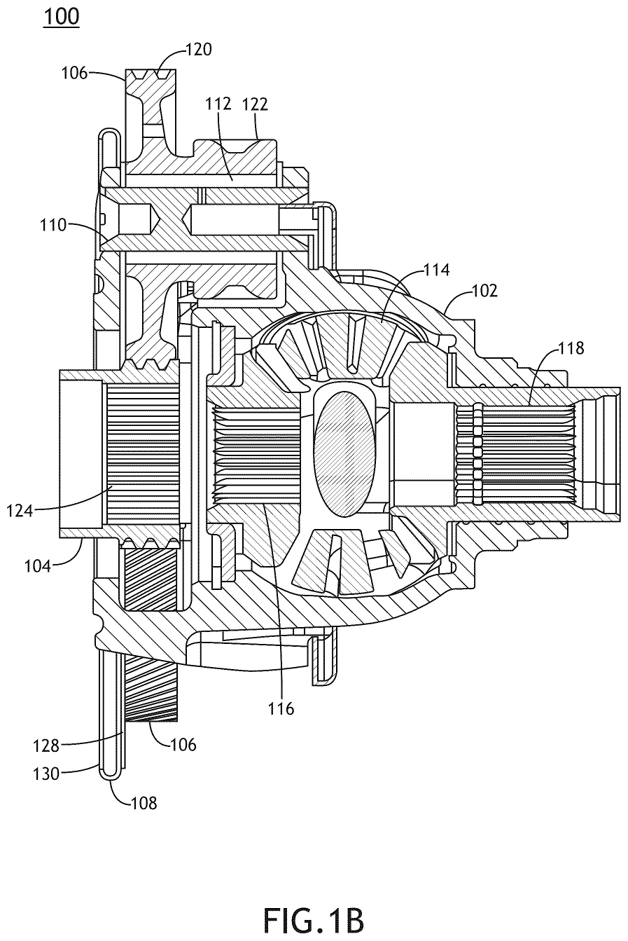

FIGS. 1A-1B depict a planetary gearset 100, in accordance with one or more embodiments of the present disclosure. The planetary gearset 100 may also be referred to as an epicyclic gearset. The planetary gearset 100 may include a gearset carrier 102, a sun gear 104, planet gears 106, an impingement pump catcher 108, pins 110, bearings 112, and/or a differential 114.

The sun gear 104 may include a central axis which may be coaxial with the central axes of the planetary gearset 100 and/or the gearset carrier 102.

The sun gear 104 may include an internal spline 124. The internal spline 124 may axially extend through the impingement pump catcher 108 and/or a portion of the gearset carrier 102. The sun gear 104 may be driven via the internal spline 124.

The sun gear 104 may engage with the planet gears 106. For example, teeth of the sun gear 104 may mesh with teeth of the planet gears 106 thereby engaging the sun gear 104 with the planet gears 106. The planet gears 106 may include central axes which may be parallel to and offset from the central axis of the planetary gearset 100, the gearset carrier 102, and/or the sun gear 104. Rotation of the sun gear 104 may cause the rotation of the planet gears 106 about the central axes of the planet gears 106. The planet gears 106 may also revolve around the sun gear 104. The planet gears 106 may revolve around the sun gear 104 in a circle which is coaxial to the central axis of the sun gear 104. The revolution of the sun gear 104 may cause both the rotation of the planet gears 106 about the central axes of the planet gears 106 and the revolution of the planet gears 106 around the sun gear 104.

The gearset carrier 102 may include any number of the planet gears 106. For example, the gearset carrier 102 may include three of the planet gears 106.

The planet gears 106 may provide a gear reduction to the sun gear 104. The sun gear 104 and the planet gears 106 may include a select diameter and number of teeth to provide the gear reduction. The diameter of the planet gears 106 may be larger than the diameter of the sun gear 104 to provide the gear reduction.

The gearset carrier 102 may hold the planet gears 106. The gearset carrier 102 may hold the planet gears 106 via the pins 110 and the bearings 112.

The pins 110 may be affixed to the gearset carrier 102. For example, the pins 110 may be affixed to the gearset carrier 102 by being press-fit into and staked to the gearset carrier 102. The pins 110 may include central axes which are parallel to and radially offset from the central axes of the planetary gearset 100, the gearset carrier 102, and/or the sun gear 104. The pins 110 may include central axes which are coaxial to the central axes of the planet gears 106 and/or the bearings 112.

The planet gears 106 may be connected to the pins 110 through the bearings 112. The bearings 112 may allow the planet gears 106 to rotate about the pins 110. The bearings 112 may include, but are not limited to, needle bearings.

The gearset carrier 102 may be coaxial with the sun gear 104. The gearset carrier 102 may include a central axis which is coaxial to the central axes of the planetary gearset 100 and/or the sun gear 104.

The planet gears 106 may cause the gearset carrier 102 to rotate relative to the sun gear 104 as the planet gears 106 revolve about the sun gear 104. For example, a torque reaction from the planet gears 106 may go through the bearings 112 and the pins 110 to the gearset carrier 102. The gearset carrier 102 and the planet gears 106 may form a revolute joint via the pins 110 and the bearings 112. Thus, the planet gears 106 may include one degree-of-freedom relative to the gearset carrier 102.

The planetary gearset 100 may be a compound planetary gearset. The planet gears 106 may be stepped-planet gears. The stepped-planet gears may include a gear portion 120 and a gear portion 122. The gear portion 122 may axially extend from the gear portion 120. The gear portion 120 and the gear portion 122 may share a common central axis. The gear portion 120 and/or the gear portion 122 may be connected to the pins 110 via the bearings 112. The gear portion 120 may engage with the sun gear 104. The gear portion 122 may not engage with the sun gear 104. A diameter of the gear portion 122 may be smaller than a diameter of the gear portion 120 to provide a gear reduction to the planetary gearset 100.

The differential 114 may be a bevel-gear differential. The differential 114 may include an internal spline 116 and/or an internal spline 118. The internal spline 116, the internal spline 118 and/or the internal spline 124 may be coaxial. The gearset carrier 102, the sun gear 104, internal spline 116, the internal spline 118, and/or the internal spline 124 may be radially offset. The internal spline 116 may be axially disposed between the internal spline 118 and the internal spline 124.

The gearset carrier 102 may house the differential 114. For example, the differential 114 may be housed within the gearset carrier 102. The gearset carrier 102 may drive the differential 114 via the rotation of the gearset carrier 102. The internal spline 116 and/or the internal spline 118 may be driven by the gearset carrier 102.

The impingement pump catcher 108 may be a fluid collection ring, a circumferential scoop, or the like. The impingement pump catcher 108 may include a plate portion 128 and a lip portion 130. The plate portion 128 and/or the lip portion 130 may be concentric to the central axis of the impingement pump catcher 108.

The plate portion 128 may be a planar surface. The plate portion 128 may be flat along a vertical plane. The plate portion 128 may not include any significant curvature along the vertical plane. The plate portion 128 may be thinner than wide or long. Although the plate portion 128 is described as a planar surface, this is not intended as a limitation of the present disclosure. It is further contemplated that the plate portion 128 may be a non-planar surface.

The lip portion 130 may radially and axially extends from the plate portion 128. The lip portion 130 may be disposed radially outwards of the plate portion 128. The lip portion 130 may be a concave shape defined by an inside diameter of the lip portion 130. For example, the lip portion 130 may include a U-shape. The inside diameter of the lip portion 130 may face radially inwards towards the central axis of the impingement pump catcher 108. The inside diameter of the lip portion 130 may be smooth. For example, the side diameter of the lip portion 130 may be free from roughness, irregularities, or projections. The inside diameter of the lip portion 130 may not include vanes by being smooth.

The planetary gearset 100 may be disposed adjacent to an impingement pump pipe 126. The impingement pump pipe 126 may be a hollow cylindrical pipe. The impingement pump pipe 126 may include a pipe inlet 134. A central axis of the pipe inlet 134 may be orthogonal to and radially offset from the central axes of the gearset carrier 102, the sun gear 104, and/or the impingement pump catcher 108. The pipe inlet 134 may be aligned with the lip portion 130. For example, the pipe inlet 134 may be aligned with the inside diameter of the lip portion 130.

The impingement pump catcher 108 is configured to rotate relative to the impingement pump pipe 126. The impingement pump catcher 108 may rotate in a circle relative to the impingement pump pipe 126. The inside diameter of the lip portion 130 may be smooth and not include vanes to allow the lip portion 130 to rotate relative to the impingement pump pipe 126. The impingement pump pipe 126 may be stationary as the impingement pump catcher 108 rotates. The impingement pump pipe 126 may not rotate with the rotation of the impingement pump catcher 108.

The impingement pump catcher 108 may be affixed to the gearset carrier 102 and rotate with the gearset carrier. The impingement pump catcher 108 may be affixed to the gearset carrier 102 by bolts, welds, stakes, or the like. For example, the plate portion 128 of the impingement pump catcher 108 may be affixed to the gearset carrier 102. The gearset carrier 102 and the impingement pump catcher 108 may form a rigid body. The gearset carrier 102 and the impingement pump catcher 108 may include zero degrees-of-freedom. The gearset carrier 102 and the impingement pump catcher 108 may be configured to rotate as the rigid body. For example, the gearset carrier 102 and the impingement pump catcher 108 may each rotate about the sun gear 104.

The impingement pump catcher 108 may be axially disposed between the gearset carrier 102 and the planet gears 106. For example, the plate portion 128 may be axially disposed between the gearset carrier 102 and the planet gears 106. The impingement pump catcher 108 may be retained by the planet gears 106 and the gearset carrier 102. The bearings 112 may include an axial thrust washer that separates the impingement pump catcher 108 from the planet gears 106. The planet gears 106 may not wear out the impingement pump catcher 108 (e.g., the plate portion 128) via the axial thrust washer. The thrust loads generated by the planet gears 106 may be borne into the bearings 112 via the axial thrust washer.

The impingement pump catcher 108 and the impingement pump pipe 126 may form an impingement pump by which fluid may be pumped. The impingement pump catcher 108 and the impingement pump pipe 126 may collect the fluid passively (e.g., without the addition of a dedicated pump assembly). The impingement pump catcher 108 and the impingement pump pipe 126 may collect the fluid using the kinetic energy supplied by the rotation of the gearset carrier 102. The impingement pump catcher 108 may trap the fluid within the lip portion 130 via the rotation of the impingement pump catcher 108. The fluid may be picked up within the lip portion 130 as the impingement pump catcher 108 and the gearset carrier 102 rotate around the sun gear 104. The fluid may be pushed radially outwards due to centrifugal forces as the impingement pump catcher 108 rotates. The impingement pump pipe 126 may collect the fluid from the impingement pump catcher 108. The fluid may be transferred to the impingement pump pipe 126 from the impingement pump catcher 108 via fluid impingement. Due to the rotation of the fluid, the fluid builds up kinetic energy, forcing the fluid into the pipe inlet 134.

A size of the lip portion 130 and the pipe inlet 134 may be based on one or more factors, such as, but not limited to, how much flow is needed from the fluid, how fast the impingement pump catcher 108 rotates, a packaging requirement of the planetary gearset 100, and the like.

The planetary gearset 100 was simulated to achieve an improvement in the flow rate of fluid into the pipe inlet 134 of approximately 1.7 times when comparing the planetary gearset 100 with the impingement pump catcher 108 against the planetary gearset 100 without the impingement pump catcher 108 (e.g., fluid impingement of the fluid into the pipe inlet 134 via splashing of the fluid caused from rotation of the gearset carrier 102) when rotated at a mid-range speed of the planetary gearset 100. It is further contemplated that the impingement pump catcher 108 may provide improvement at low-range and high-range speeds of the impingement pump catcher 108.

The lip portion 130 may be continuous or discontinuous. For example, the lip portion 130 may be discontinuous and define a notch 132. The notch 132 may permit assembling the pipe inlet 134 of the impingement pump pipe 126 with the inside diameter of the lip portion 130. It is further contemplated that the lip portion 130 may be continuous while permitting assembly of the pipe inlet 134 with the inside diameter of the lip portion 130. For example, the notch 132 may be removed by design. Removing the notch 132 may be beneficial to prevent leakage of fluid through the notch 132.

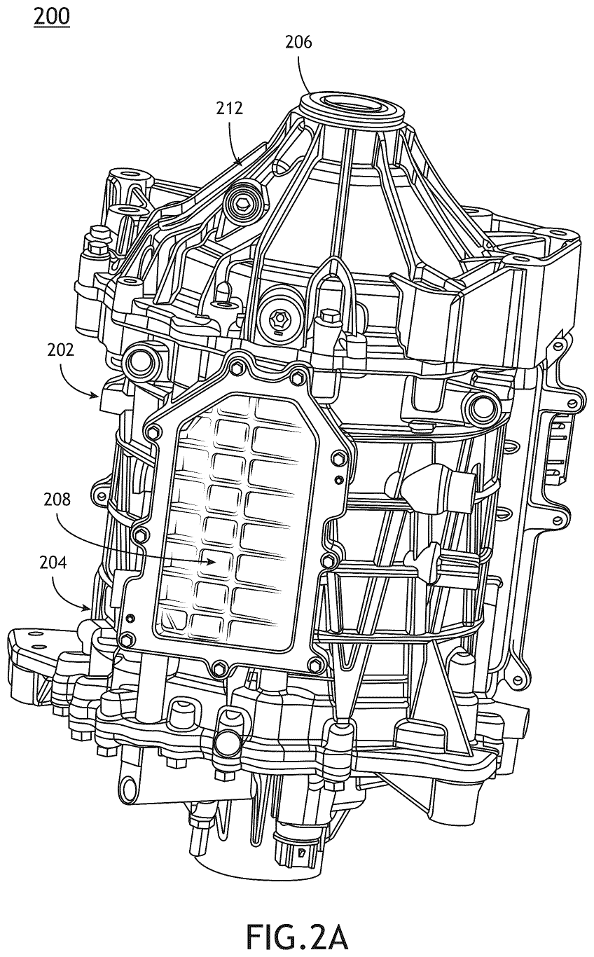

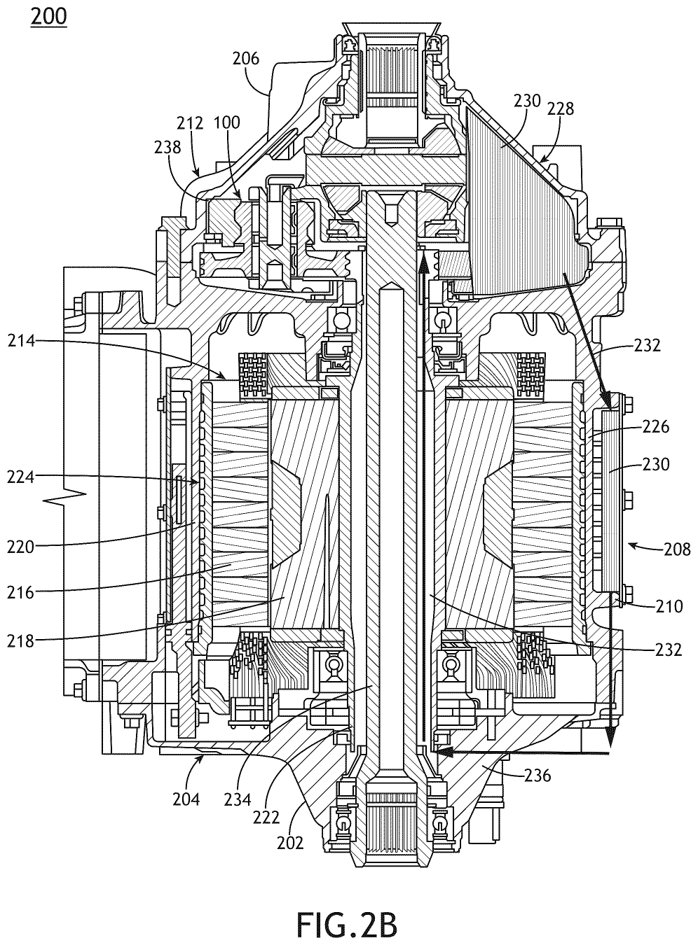

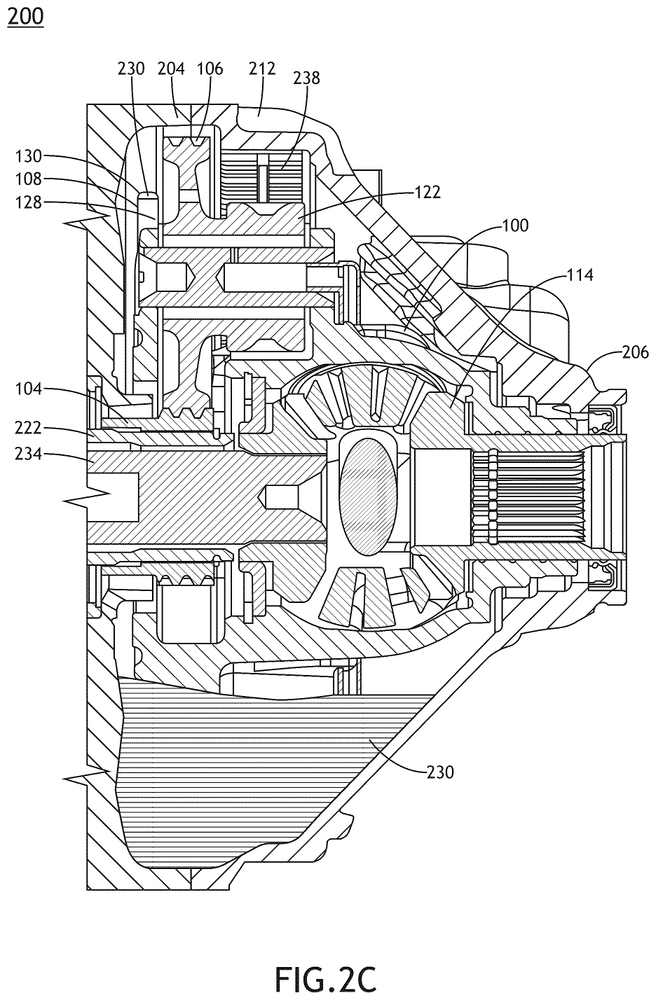

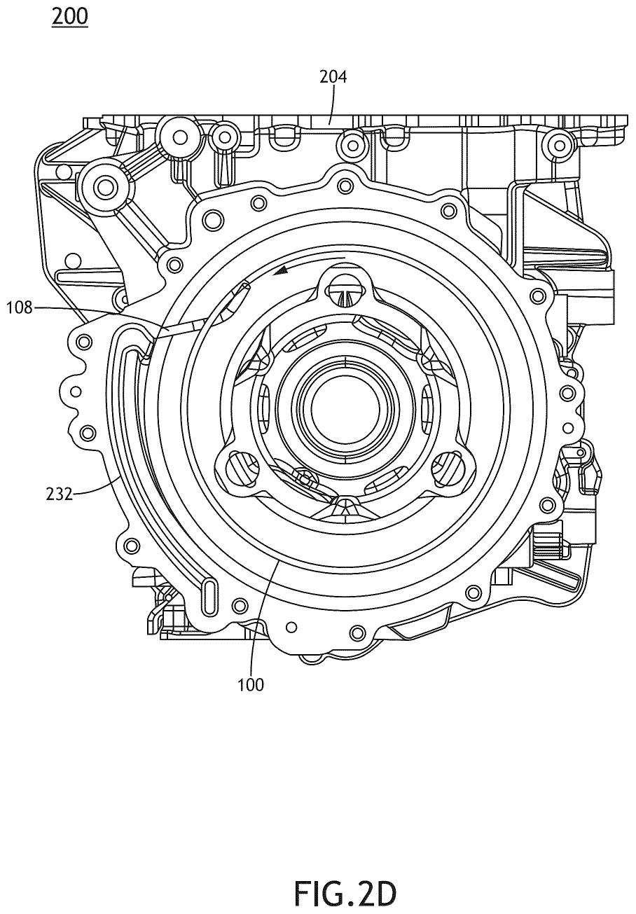

FIGS. 2A-2D depict an electric drive unit 200, in accordance with one or more embodiments of the present disclosure. The electric drive unit 200 (“EDU”) may be an electric axle (“e-axle”). The electric drive unit 200 may include the planetary gearset 100, the impingement pump pipe 126, a housing 202, a motor housing 204, a gearbox 206, a heat exchanger 208, a fluid chamber 210, a gearbox housing 212, an electric motor 214, a stator 216, a rotor 218, a stator carrier 220, a rotor shaft 222, a stator fluid jacket 224, a fluid chamber bottom wall 226, a gearbox sump 228, a fluid 230, a fluid circuit 232, an output shaft 234, a passage 236, and/or a ring gear 238.

The housing 202 may be a cast aluminum housing. The housing 202 may be formed in multiple parts. The housing 202 can be functionally divided into the motor housing 204 and the gearbox housing 212. The gearbox housing 212 may be affixed to the motor housing 204 using one or more fasteners (not depicted).

The impingement pump pipe 126 may be affixed to the housing 202. For example, the impingement pump pipe 126 may be affixed to motor housing 204 of the housing 202.

The gearbox 206 may include the planetary gearset 100, the impingement pump pipe 126, the gearbox housing 212, the gearbox sump 228, and the ring gear 238. The gearbox housing 212 may house the planetary gearset 100. The gearbox housing 212 may define the gearbox sump 228 and the ring gear 238. The ring gear 238 may also be referred to as an annulus.

The gearbox sump 228 may be disposed radially outwards of and axially aligned with the planetary gearset 100. The planet gears 106 and/or the impingement pump catcher 108 may radially extend into the gearbox sump 228. The gearbox housing 212 may define the gearbox sump 228. The gearbox sump 228 may be disposed at a bottom of the gearbox 206. The gearbox sump 228 may be a fluid reservoir. The gearbox sump 228 may hold the fluid 230. The fluid 230 may include oil or another fluid.

The ring gear 238 may be disposed radially outwards and axially aligned with the planet gears 106. The planet gears 106 may engage with the ring gear 238. For example, the gear portion 122 of the planet gears 106 may engage with the ring gear 238. The gear portion 122 of the planet gears 106 may engage with the ring gear 238 to provide a gear reduction relative to the gear portion 120.

The heat exchanger 208 may be integrated, or integral with, the motor housing 204. That is, the existing planned casting process for the motor housing 204 may be used to form the heat exchanger 208. The heat exchanger 208 may be located on one or more sides of the electric drive unit 200. The heat exchanger 208 may be disposed radially outwards of the electric motor 214. A fluid chamber 210 of the heat exchanger 208 may be formed in an outer surface (for example, by casting) of the motor housing 204.

The motor housing 204 may house the electric motor 214. The electric motor 214 may be a dynamo-electric machine which converts electrical energy to mechanical energy by electromagnetic means. The electric motor 214 may include the stator 216, the rotor 218, the stator carrier 220, and the rotor shaft 222.

The stator 216 may include the stator carrier 220. The stator 216 may be affixed to the motor housing 204. The stator 216 may be disposed radially outwards of and axially aligned with the rotor 218. The stator 216 may be disposed radially inwards of and axially aligned with the heat exchanger 208.

The stator carrier 220 may be a housing for the components of the stator 216. The stator carrier 220 may encapsulate a stator core, a stator winding, and the like. The stator core may be made of stacks of one or more stacks of lamination. The stator core may define one or more slots for the winding. The winding of the stator 216 may disposed in the slots of the stator core.

The rotor 218 may include the rotor shaft 222. The rotor 218 may be disposed within a central axis of the stator 216. The rotor 218 may or may not be supported by the stator 216 via one nor more bearings. The magnetic field induced by the stator 216 may cause the rotor 218 to rotate relative to the stator 216. The rotor 218 may perform work on one or more external components via the rotation of the rotor 218.

The rotor shaft 222 may engage to the sun gear 104 of the planetary gearset 100. For example, the rotor shaft 222 may engage to the internal spline 124 of the sun gear 104. The electric motor 214 may drive the sun gear 104 of the planetary gearset 100 via the rotor shaft 222.

The electric drive unit 200 may be a coaxial rotor system. The output shaft 234 may be disposed radially inwards of and axially aligned with the rotor 218. The output shaft 234 may be engaged with the differential 114. For example, the output shaft 234 may be engaged with the internal spline 116 of the differential 114. The output shaft 234 may axially extend through the rotor shaft 222 and the sun gear 104 and engage with the internal spline 116 of the differential 114.

A pair of wheels of a vehicle's drivetrain may be coupled to opposing ends of the differential 114. For example, the pair of wheels may be coupled to opposing ends of the differential 114 via the internal spline 116 of the differential 114 and via the output shaft 234. The differential 114 may enabling turning the wheels at independent speeds for cornering.

The fluid 230 may flow in the fluid circuit 232 from the gearbox sump 228, through the heat exchanger 208, through the passage 236, along the rotor shaft 222, and back to the gearbox sump 228.

The gearbox 206 may collect and distribute the fluid 230 from the gearbox sump 228 to the heat exchanger 208. The impingement pump catcher 108 may pump the fluid 230 from the gearbox sump 228 to the impingement pump pipe 126 as the impingement pump catcher 108 rotates. The rotation of the impingement pump catcher 108 causes the impingement pump catcher 108 to pump the fluid 230 from the gearbox sump 228 into the pipe inlet 134. A portion of the pumping action may also be performed via centrifugal pumping, where the fluid may be slung radially outward into the impingement pump catcher 108 from fluid collecting on the plate portion 128 and picked up via the pipe inlet 134. The fluid 230 may be transferred from the gearbox sump 228 to the impingement pump pipe 126 via the lip portion 130 of the impingement pump catcher 108. The fluid 230 may impinge on the pipe inlet 134, pumping the fluid 230 into the impingement pump pipe 126, and may build fluid pressure in the fluid circuit 232, thereby pushing the fluid 230 through the fluid circuit 232 to the heat exchanger 208. The fluid 230 may be routed from the impingement pump pipe 126 into the heat exchanger 208.

The heat exchanger 208 may receive and cool the fluid 230. The heat exchanger 208 may cool the fluid 230 with a coolant fluid that is disposed on the opposing side of the fluid chamber bottom wall 226 within the stator fluid jacket 224. The stator 216 may include a stator fluid jacket 224 formed, and bounded, by the stator carrier 220 and a fluid chamber bottom wall 226 of the fluid chamber 210. The stator fluid jacket 224 may be formed by the stator carrier 220 and the fluid chamber bottom wall 226. The stator carrier 220 and the fluid chamber bottom wall 226 may form an inner wall and an outer wall, respectively, of the stator fluid jacket 224. The stator fluid jacket 224 may be filled with a coolant fluid. The coolant fluid may also be referred to as coolant, antifreeze, or the like. The coolant fluid may include a water-glycol mixture, for example. The coolant fluid may be for cooling of the stator 216 and for cooling the fluid 230 that is disposed within the fluid chamber 210 of the heat exchanger 208. The heat exchanger 208 may use the stator fluid jacket 224 to cool the fluid 230 within the fluid chamber 210. The fluid chamber bottom wall 226 may be in contact with the stator fluid jacket 224 volume on an inner surface and is in contact with the fluid from the heat exchanger 208 on an outer surface and functions as a “cool wall”. The contact may also allow heat exchanging of the fluid 230 without added fluid pressure losses or the addition of additional circuits. The cavity defined by the stator fluid jacket 224 can be filled with a water-glycol mixture and the fluid chamber 210 of the heat exchanger 208 can be filled with the fluid 230. It is contemplated that a variety of different types of fluids can be utilized within the cavity defined by the stator fluid jacket 224 and the fluid chamber 210.

The fluid 230 may be routed from the heat exchanger 208 to the rotor shaft 222. The fluid 230 may be routed to the rotor shaft 222 along the fluid circuit 232 in the housing 202. The fluid 230 may be routed along the fluid circuit 232 to the rotor shaft 222 via a passage 236 formed in the housing 202. The passage 236 is in fluid communication with the rotor shaft 222 such that fluid flowing through the passage 236 exits the passage 236 into a cavity defined between the rotor shaft 222 and the output shaft 234.

The fluid 230 may flow along the inner diameter of the rotor shaft 222 and along the outer diameter of the output shaft 234. The fluid 230 may be exposed to both the rotor shaft 222 and the output shaft 234. In the coaxial system, the fluid 230 is delivered into a hollow defined by the rotor shaft 222 and the output shaft 234. The fluid 230 may provide cooling of the rotor shaft 222. The fluid 230 may then return from the end of the rotor shaft 222 to the gearbox sump 228. For example, the fluid 230 may return from the end of the rotor shaft 222 via a drilled passage between the motor housing 204 and the sun gear 104 and/or a gap between the output shaft 234 and the rotor shaft 222.

The term “axial” and derivatives thereof, such as “axially,” shall be understood to refer to a direction along the axis of a rotor shaft configured to rotate about the axis in operation of the apparatus described herein. Further, the term “radial” and derivatives thereof, such as “radially,” shall be understood in relation to the axis of the aforementioned rotor shaft. For example, “radially outwards” refers to further away from the axis, while “radially inwards” refers to nearer to the axis. The term “circumferential” and derivatives thereof, such as “circumferentially,” shall be understood in relation to the axis of the rotor shaft.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 Planetary gearset
102 Gearset carrier
104 Sun gear
106 Planet gears
108 Impingement pump catcher
110 Pins
112 Bearings
114 Differential
116 Internal spline
118 Internal spline
120 Gear portion
122 Gear portion
124 Internal spline
126 Impingement pump pipe
128 Plate portion
130 Lip portion
132 Notch
134 Pipe inlet
200 Electric drive unit
202 Housing
204 Motor housing
206 Gearbox
208 Heat exchanger
210 Fluid chamber
212 Gearbox housing
214 Electric motor
216 Stator
218 Rotor
220 Stator carrier
222 Rotor shaft
224 Stator fluid jacket
226 Fluid chamber bottom wall
228 Gearbox sump
230 Fluid
232 Fluid circuit
234 Output shaft
236 Passage
238 Ring gear

What is claimed:

1. A planetary gearset comprising:
a sun gear;
a plurality of planet gears, wherein the plurality of planet gears engage with the sun gear, wherein the plurality of planet gears are configured to revolve around the sun gear;
a gearset carrier, wherein the gearset carrier holds the plurality of planet gears, wherein the plurality of planet gears cause the gearset carrier to rotate relative to the sun gear as the plurality of planet gears revolve around the sun gear;
a differential, wherein the gearset carrier houses the differential, wherein the gearset carrier is configured to drive the differential via rotation of the gearset carrier; and
an impingement pump catcher, wherein the impingement pump catcher is affixed to the gearset carrier and is configured to rotate with the gearset carrier, wherein the impingement pump catcher comprises a plate portion and a lip portion, wherein the lip portion radially and axially extends from the plate portion.

2. The planetary gearset of claim 1, wherein the plurality of planet gears comprise a plurality of central axes which are parallel to and offset from a central axis of the sun gear.

3. The planetary gearset of claim 1, comprising a plurality of pins and a plurality of bearings, wherein the gearset carrier holds the plurality of planet gears via the plurality of pins and the plurality of bearings.

4. The planetary gearset of claim 3, wherein the plurality of pins are affixed to the gearset carrier, wherein the plurality of planet gears are connected to the plurality of pins through the plurality of bearings, wherein the plurality of bearings allow the plurality of planet gears to rotate about the plurality of pins.

5. The planetary gearset of claim 4, wherein the plurality of planet gears, the plurality of pins, and the plurality of bearings are coaxial.

6. The planetary gearset of claim 1, wherein the gearset carrier is coaxial with the sun gear.

7. The planetary gearset of claim 1, wherein the differential comprises a first internal spline and a second internal spline, wherein the first internal spline and the second internal spline are coaxial with the sun gear, wherein the first internal spline and the second internal spline are driven by the gearset carrier.

8. The planetary gearset of claim 1, wherein the plurality of planet gears are stepped-planet gears comprising a first gear portion and a second gear portion, wherein the second gear portion axially extends from the first gear portion, wherein the first gear portion engages with the sun gear, wherein the second gear portion does not engage with the sun gear.

9. The planetary gearset of claim 1, wherein the sun gear comprises an internal spline, wherein the internal spline axially extends through the impingement pump catcher.

10. The planetary gearset of claim 1, wherein the lip portion is disposed radially outwards of the plate portion.

11. The planetary gearset of claim 1, wherein the lip portion is a concave shape defined by an inside diameter of the lip portion.

12. The planetary gearset of claim 11, wherein the inside diameter faces radially inwards towards a central axis of the impingement pump catcher.

13. The planetary gearset of claim 11, wherein the lip portion is a U-shape.

14. The planetary gearset of claim 1, wherein the plate portion is axially disposed between the gearset carrier and the plurality of planet gears.

15. The planetary gearset of claim 1, wherein the lip portion is continuous.

16. The planetary gearset of claim 1, wherein the lip portion is discontinuous and defines a notch.

17. A gearbox comprising:
a planetary gearset comprising:
a sun gear;
a plurality of planet gears, wherein the plurality of planet gears engage with the sun gear, wherein the plurality of planet gears are configured to revolve around the sun gear;
a gearset carrier, wherein the gearset carrier holds the plurality of planet gears, wherein the plurality of planet gears cause the gearset carrier to rotate relative to the sun gear as the plurality of planet gears revolve around the sun gear;
a differential, wherein the gearset carrier houses the differential, wherein the gearset carrier is configured to drive the differential via rotation of the gearset carrier; and
an impingement pump catcher, wherein the impingement pump catcher is affixed to the gearset carrier and is configured to rotate with the gearset carrier, wherein the impingement pump catcher comprises a plate portion and a lip portion, wherein the lip portion radially and axially extends from the plate portion;
an impingement pump pipe comprising a pipe inlet, wherein the pipe inlet is aligned with the lip portion; and
a gearbox housing, wherein the gearbox housing defines:
a gearbox sump, wherein the plurality of planet gears and the impingement pump catcher radially extend into the gearbox sump, wherein the gearbox sump is configured to hold a fluid, wherein rotation of the impingement pump catcher causes the impingement pump catcher to pump the fluid from the gearbox sump into the pipe inlet; and
a ring gear, wherein the ring gear is disposed radially outwards of and axially aligned with the plurality of planet gears, wherein the plurality of planet gears engage with the ring gear.

18. The gearbox of claim 17, wherein a central axis of the pipe inlet is orthogonal to and radially offset from central axes of the gearset carrier, the sun gear, and the impingement pump catcher.

19. An electric drive unit comprising:
a gearbox comprising:
a planetary gearset comprising:
a sun gear;
a plurality of planet gears, wherein the plurality of planet gears engage with the sun gear, wherein the plurality of planet gears are configured to revolve around the sun gear;
a gearset carrier, wherein the gearset carrier holds the plurality of planet gears, wherein the plurality of planet gears cause the gearset carrier to rotate relative to the sun gear as the plurality of planet gears revolve around the sun gear;
a differential, wherein the gearset carrier houses the differential, wherein the gearset carrier is configured to drive the differential via rotation of the gearset carrier; and
an impingement pump catcher, wherein the impingement pump catcher is affixed to the gearset carrier and is configured to rotate with the gearset carrier, wherein the impingement pump catcher comprises a plate portion and a lip portion, wherein the lip portion radially and axially extends from the plate portion;
an impingement pump pipe comprising a pipe inlet, wherein the pipe inlet is aligned with the lip portion; and
a gearbox housing, wherein the gearbox housing defines:
a gearbox sump, wherein the plurality of planet gears and the impingement pump catcher radially extend into the gearbox sump, wherein the gearbox sump is configured to hold a fluid, wherein rotation of the impingement pump catcher causes the impingement pump catcher to pump the fluid from the gearbox sump into the pipe inlet; and
a ring gear, wherein the ring gear is disposed radially outwards of and axially aligned with the plurality of planet gears, wherein the plurality of planet gears engage with the ring gear;
an electric motor comprising:
a rotor, wherein the rotor is coupled to the sun gear; and
a stator; and
an output shaft, wherein the output shaft is coupled to the differential, wherein the output shaft is disposed radially inwards of and axially aligned with the rotor.

20. The electric drive unit of claim 19, comprising a motor housing, wherein the motor housing houses the electric motor, wherein the gearbox housing is affixed to the motor housing, wherein the impingement pump pipe is affixed to the motor housing.
